(19) United States
(12) Patent Application Publication
(10) Pub. No.: US 2009/0009720 A1
(43) Pub. Date: Jan. 8, 2009

(54) OPTICAL ENGINE

(75) Inventors: Mei-Ling Chen, Hsinchu (TW); Chao-Shun Chen, Hsinchu (TW); Fu-Ming Chuang, Hsinchu (TW); S-Wei Chen, Hsinchu (TW); Cheng-Shun Liao, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 12/036,734

(22) Filed: Feb. 25, 2008

(30) Foreign Application Priority Data
Jul. 6, 2007 (TW) 96211048

(51) Int. Cl. G02B 27/28

(52) U.S. Cl. 353/20

(57) ABSTRACT

An optical engine including a beam splitting and combining system, which includes a first polarizing beam splitting (PBS) unit, a dichroic unit and a second PBS unit, is provided. A first color beam is reflected by the first PBS unit, is reflected by a first light valve, and passes through the first PBS unit sequentially. A second color beam passes through the first PBS unit, is reflected by a second light valve, and is reflected by the first PBS unit sequentially. The dichroic unit is disposed on an optical path of the first and second color beams. The second PBS unit is capable of allowing a third color beam to travel to a third light valve and allowing the third color beam reflected from the third light valve to travel to the dichroic unit. The dichroic unit is capable of combining the first, second and third color beams.

### CROSS-REFERENCE TO RELATED APPLICATION

This application claims the priority benefit of Taiwan application serial no. 96211048, filed on Jul. 6, 2007. The entirety the above-mentioned patent application is hereby incorporated by reference herein and made a part of specification.

### BACKGROUND OF THE INVENTION

1. Field of the Invention

The present invention relates to an optical engine, and more particularly to an optical engine using coherent light sources.

2. Description of Related Art

Referring to FIG. 1, a conventional optical engine 100 includes an ultra high pressure mercury lamp (UHP mercury lamp) 110, a light uniforming module 120, a beam splitting and combining system 130, three liquid-crystal-on-silicon panels (LCOS panels) 140a,140b and 140c, and a projection lens 150. The light uniforming module 120 includes two lens arrays 122a and 122b, a polarization conversion system (PCS) 124 and a lens 126. The beam splitting and combining system 130 includes a dichroic unit 132, a dichroic mirror 134, three polarizing beam splitting prisms (PBS prisms) 136a, 136b and 136c, and an X cube 138, and the dichroic unit 132 is formed with two dichroic mirrors 132a and 132b which intersect each other. The UHP mercury lamp 110 is capable of emitting a white beam 112. The white beam 112 has a single polarization direction after passing through the PCS.

The white beam 112 may be considered as formed with many partial beams with various wavelengths. The red partial beam 112a of the white beam 112 is reflected by the dichroic mirror 132a, is reflected by the PBS prism 136a, is reflected by the PBS prism 136a, is reflected by the X cube 138, and travels to the projection lens 150 sequentially. The green partial beam 112b of the white beam 112 is reflected by the dichroic mirror 132b, is reflected by the dichroic mirror 134, is reflected by the PBS prism 136b, is reflected by the PBS prism 136b, passes through the X tube 138 and travels to the projection lens 150 sequentially. The blue partial beam 112c of the white beam 122 is reflected by the dichroic mirror 132b, passes through the dichroic mirror 134, is reflected by the PBS prism 136c, is reflected by the PBS prism 136c, is reflected by the X tube 138, and travels to the projection lens 150 sequentially.

In the conventional optical engine 100, the intensity of the white beam 112 reduces by 15˜20% after the white beam 112 passes through the In addition, since the light emitting angle of the is around 25°˜30°, more lenses, such as lens arrays 112a and 112b, lens 126 and other lenses not shown, are needed to converge the white beam 112, which makes the length of optical path that the white beam 112 travels longer, so as to increase the volume of the optical engine 100.

### SUMMARY OF THE INVENTION

The present invention provides an optical engine with simpler structure, smaller volume, and the optical engine provides display images with higher brightness.

An embodiment of the present invention provides an optical engine including a first light valve, a second light valve, a third light valve, a first coherent light source, a second coherent light source, a third coherent light source and a beam splitting and combining system. The first coherent light source is capable of providing a first color beam with a first polarization direction. The second coherent light source is capable of providing a second color beam with a second polarization direction. The third coherent light source is capable of providing a third color beam. The beam splitting and combining system includes a first polarizing beam splitting unit (PBS unit), a dichroic unit and a second PBS unit. The first color beam incident from a light source side of the first PBS unit and having a first polarization direction is reflected by the first PBS unit, is reflected by the first light valve, and passes through the first PBS unit sequentially. The second color beam incident from the light source side of the first PBS unit and having a second polarization direction passes through the first PBS unit, is reflected by the second light valve, and is reflected by the first PBS unit to combine with the first color beam sequentially. The dichroic unit is disposed on an optical path of the first color beam and the second color beam combined together from the first PBS unit. The second PBS unit is capable of allowing the third color beam to travel to the third light valve and capable of allowing the third color beam reflected by the third light valve to travel to the dichroic unit. The dichroic unit is capable of combining the first, second and third color beams into an image beam.

In an embodiment of the present invention, the first color beam from the first coherent light source and the second color beam from the second coherent light source travel to the PBS unit, and are then emitted from a first surface of the PBS unit. The third color beam from the third coherent light source travel to the PBS unit, and is then emitted from a second surface of the PBS unit. The third color beam emitted from the second surface is reflected back to the second surface by the third light valve. The dichroic unit is disposed on an optical path of the first color beam and the second color beam from the first surface. The first color beam from the first surface passes through the dichroic unit, is reflected by the first light valve, passes through the dichroic unit, and returns to the first surface sequentially. The second color beam from the first surface is reflected by the dichroic unit, is reflected by the second light valve, is reflected by the dichroic unit, and returns to the first surface sequentially. The first, second and third color beams returned from the first, second and third light valves to the PBS unit are combined into an image beam by the PBS unit.

In an embodiment of the present invention, the first color beam from the first coherent light source and the second color beam from the second coherent light source travel to the first dichroic unit, and are then emitted from a first surface of the first dichroic unit. The third color beam from the third coherent light source travels to the first dichroic unit, and is then emitted from a second surface of the first dichroic unit. The first color beam from the first dichroic unit is reflected by the first PBS unit, is reflected by the first light valve, and passes through the first PBS unit sequentially. The second color beam from the first dichroic unit passes through the first PBS unit, is reflected by the second light valve, and is reflected by the first PBS unit to combine with the first color beam sequentially. The second dichroic unit is disposed on an optical path of the first color beam and the second color beam combined together from the first. PBS unit sequentially. The second PBS unit is capable of allowing the third color beam from the first dichroic unit to travel to the third light valve and capable of allowing the third color beam reflected by the third light valve to travel to the second dichroic unit. The second dichroic unit is capable of combining the first, second and third color beams into an image beam.

The beam splitting and combining system according to an embodiment of the present invention uses two PBS units and a dichroic unit to achieve the beam splitting and combining effect, and the structure thereof is simpler than that of the prior arts. In addition, in the optical engine, since the beams emitted from the coherent light sources are polarized beam, the optical engine doesn't need to use polarization conversion system (PCS). Therefore, the intensity of the beams is not lost due to the beams passing through the PCS. In this way, the optical engine is able to provide display images with higher brightness.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTIONS OF DRAWINGS

FIG. 1 is a structural diagram of a conventional optical engine.

FIG. 2 is a structural diagram of a beam splitting and combining system according to an embodiment of the present invention.

FIG. 3 is a structural diagram of a beam splitting and combining system according to another embodiment of the present invention.

FIG. 4 is a structural diagram of a beam splitting and combining system according to yet another embodiment of the present invention.

FIG. 5 is a structural diagram of an optical engine according to an embodiment of the present invention.

FIG. 6 is a structural diagram of an optical engine according to another embodiment of the present invention.

FIG. 7 is a structural diagram of an optical engine according to yet another embodiment of the present invention.

FIG. 8 is a structural diagram of an optical engine according to still another embodiment of the present invention.

FIG. 9 is a structural diagram of an optical engine according to yet still another embodiment of the present invention.

FIG. 10 is a curve of reflective rate of P-polarization light beams as a function of wavelength.

FIG. 11 is a curve of penetration rate of S-polarization light beams as a function of wavelength.

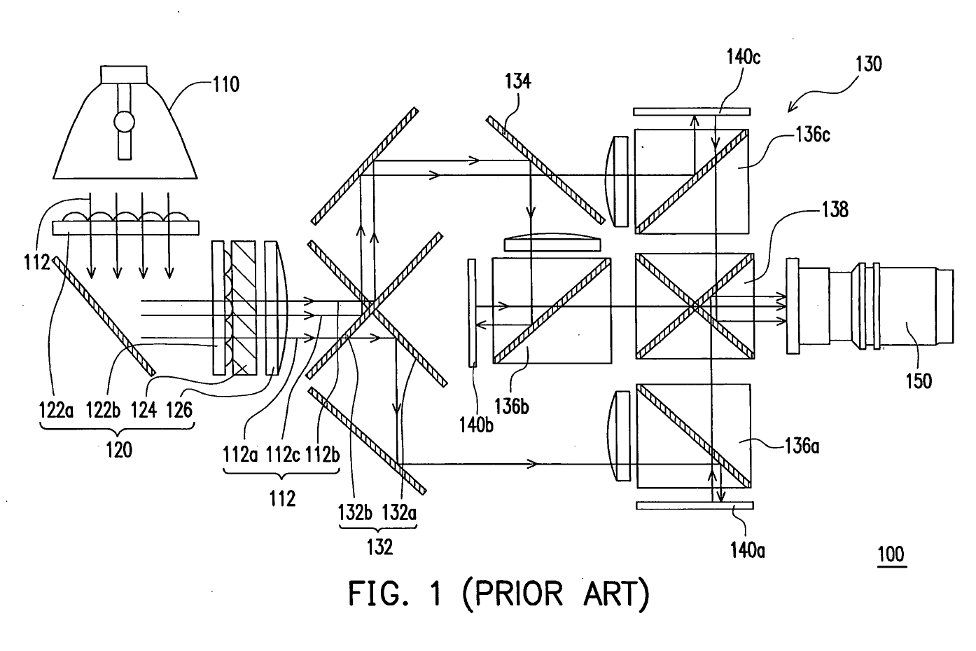

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

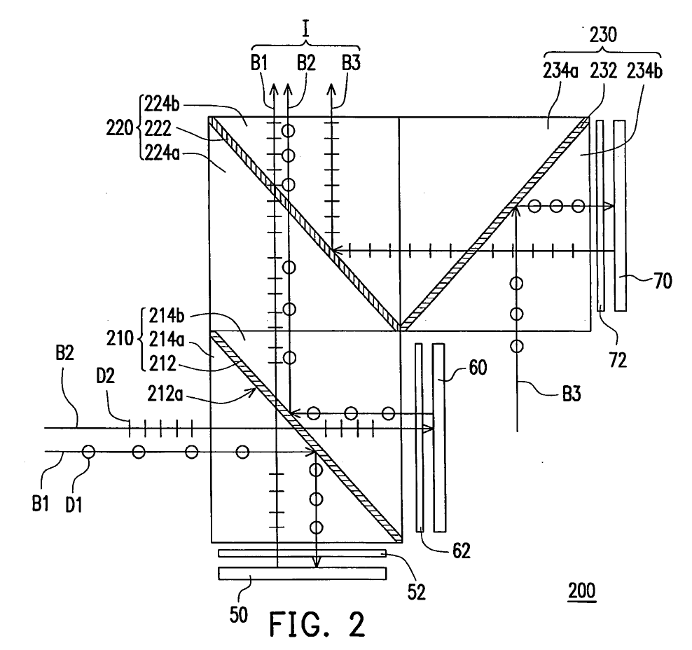

FIG. 2 is a structural diagram of a beam splitting and combining system according to an embodiment of the present invention. Referring to FIG. 2, a beam splitting and combining system 200 of the present embodiment includes a first polarizing beam splitting (PBS) unit 212, a dichroic unit 222 and a second PBS unit 232. A first color beam B1 incident from a light source side 212a of the first PBS unit 212 and having a first polarization direction D1 is reflected by the first PBS unit 212, is reflected by a first light valve 50, and passes through the first PBS unit 212 sequentially. A second color beam B2 incident from a light source side 212a of the first PBS unit 212 and having a second polarization direction D2 passes through the first PBS unit 212, is reflected by a second light valve 60, and is reflected by the first PBS unit 212 to combine with the first color beam B1 sequentially.

In the present embodiment, the first polarization direction D1 is substantially perpendicular to the second polarization direction D2. More particularly, the first polarization direction D1 and the second polarization direction D2 are, for example, S polarization direction and P polarization direction, respectively. The first light valve 50 and the second light valve 60 are, for example, LCOS panels or other appropriate reflective valves. The first color beam B1 with S polarization direction is reflected to the first light valve 50 by the first PBS unit 212. Then, the first color beam B1 carries the image provided by the first light valve 50, and is reflected by the first light valve 50 to become the first color beam B1 with P polarization direction. Next, the first color beam B1 with P polarization direction passes through the first PBS unit 212. On the other hand, the second color beam B2 with P polarization direction passes through the first PBS unit 212 and travels to the second light valve 60. Then, the second color beam B2 carries the image provided by the second light valve 60 and is reflected by the second light valve 60 to become the second color beam B2 with S polarization direction. Next, the second color beam B2 with S polarization direction is reflected by the first PBS unit 212 to combine with the first color beam B1. In other embodiments, the first polarization direction D1 and the second polarization direction D2 may also be P polarization direction and S polarization direction respectively, or be other appropriate polarization directions respectively.

The dichroic unit 222 is disposed on the optical path of the first color beam B1 and the second color beam B2 combined together from the first PBS unit 212. The second PBS unit 232 is capable of allowing a third color beam B3 to travel to a third light valve 70 and capable of allowing the third color beam B3 reflected by the third light valve 70 to travel to the dichroic unit 222. The dichroic unit 222 is capable of combining the first, second and third color beams B1, B2 and B3 into an image beam I.

In the present embodiment, the polarization direction of the third color beam B3 is substantially the same as the first polarization direction D1. More particularly, the polarization direction of the third color beam B3 is, for example, S polarization direction. The third color beam B3 with S polarization direction is reflected to the third light valve 70 by the second PBS unit 232. Next, the third color beam B3 carries the image provided by the third light valve 70 and is reflected by the third light valve 70 to become the third color beam B3 with P polarization direction. The third light valve 70 is, for example, an LCOS panel or another appropriate reflection valve. Then, the third color beam B3 with P polarization direction passes through the second PBS unit 232 and travels to the dichroic unit 222. The first color beam B1 and the third color beam B3 are incident from two opposite sides of the dichroic unit 222, respectively. In addition, in the present embodiment, the dichroic unit 222 is capable of allowing the first color beam B1 and the second color beam B2 to pass through, and is capable of reflecting the third color beam B3. Therefore, the dichroic unit 222 is capable of combining the first, second and third color beams B1, B2 and B3 into the image beam I. However, in other embodiments, the dichroic unit may also reflect the first color beam B1 and the second color beam B2, and allow the third color beam B3 to pass through, so as to achieve the effect of combining the first, second and third color beams B1, B2 and B3.

In addition, in other embodiments, the polarization direction of the third color beam B3 may also be substantially the same as the second polarization direction D2 or be another appropriate direction. For example, in another embodiment, the polarization direction of the third beam B3 is, for example, P polarization direction. The third color beam B3 with P polarization direction passes through the second PBS unit 232 and is reflected by the third light valve 70 to become the third color beam with S polarization direction. Then, the third color beam B3 with S polarization direction is reflected by the second PBS unit 232 to the dichroic unit 222.

In the present embodiment, the beam splitting and combining system 200 further includes two prisms 214a and 214b which respectively lean against the two opposite sides of the first PBS unit 212. One of the prisms (i.e. the prism 214a) is located on the optical path between the first PBS unit 212 and the first light valve 50, and the other one of the prisms (i.e. the prism 214b) is located on the optical path between the first PBS unit 212 and the second light valve 60. The first PBS unit 212 is, for example, a PBS film. The prism 214a, the prism 214b and the first PBS unit 212 form a polarizing beam splitting prism (PBS prism) 210.

In addition, the beam splitting and combining system 200 may further include two prisms 224a and 224b which respectively lean against two opposite sides of the dichroic unit 222. One of the prisms (i.e. the prism 224a) is located on the optical path between the first PBS unit 212 and the dichroic unit 222, and the other one of the prisms (i.e. the prism 224b) is located on the optical path between the dichroic unit 222 and the second PBS unit 232. The dichroic unit 222 is, for example, a dichroic film. The prism 224a, the prism 224b and the dichroic unit 222 form a dichroic prism 220.

In addition, the beam splitting and combining system 200 further includes two prisms 234a and 234b which respectively lean against two opposite sides of the second PBS unit 232. One of the prisms (i.e. the prism 234a) is located on the optical path between the dichroic unit 222 and the second PBS unit 232. The second PBS unit 232 is, for example, a PBS film. The prism 234a, the prism 234b and the second PBS unit 232 form a PBS prism 230. In the present embodiment, the third light valve 70 is disposed at the location close to one side of the prism 234b. However, in other embodiments, the third light valve 70 may also be disposed at the location close to one side of the prism 234a.

In the present embodiment, one of the first through third color beams B1˜B3 is, for example, a red color beam, another color beam is, for example, green color beam, and the other color beam is, for example, a blue color beam. In this way, the first through third color beams B1˜B3 are combined into the image beam I with various colors. In addition, in order to increase the contrast of the image beam I, the first through third color beams B1˜B3 may respectively pass through quarter-wave plates 52, 62 and 72 before the first through third color beams B1˜B3 are incident on the first through third light valves 50˜70, and then pass through the quarter-wave plates 52, 62 and 72 again after they are reflected by the first through third light valves 50˜70.

Basing on the above descriptions, the beam splitting and combining system 200 of the present embodiment uses two PBS units (i.e. the first and second PBS units 212 and 232) and a dichroic unit 222 to achieve the beam splitting and combining effect, such that the structure of the beam splitting and combining system 200, compared with the prior arts, is simpler. Thus, the volume of the beam splitting and combining system 200 is smaller, and the cost thereof is lower. In addition, the beam splitting and combining system 200 of the present embodiment may be applied in the optical engine with coherent light sources.

It should be noted that the first and second PBS units 212 and 232 and the dichroic unit 222 are not limited to be disposed at the boundary of two prisms in form of film. In other embodiments, at least one of the first PBS unit 212, the second PBS unit. 232 and the dichroic unit 222 may be plate-shaped, and prisms may not be needed to fix the shape and the location thereof. Two embodiments will be used as examples to describe in detail below.

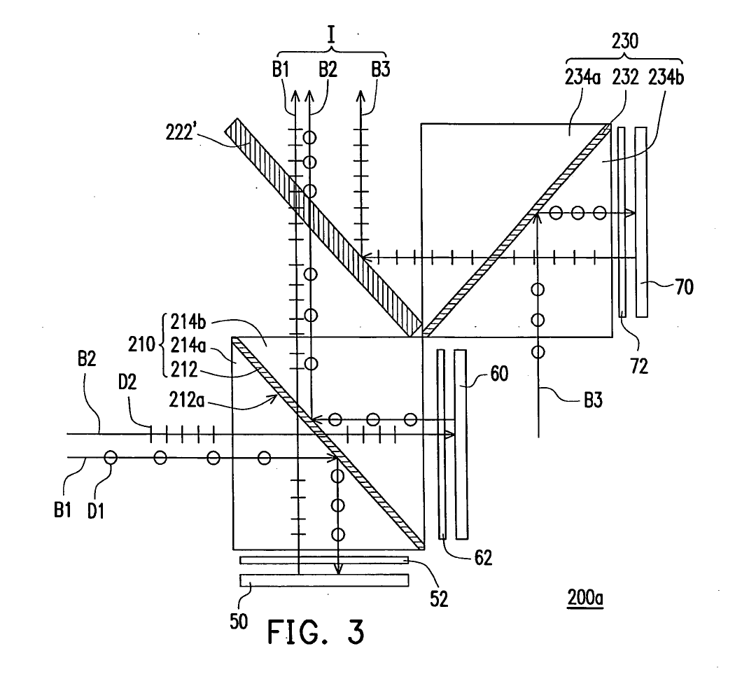

FIG. 3 is a structural diagram of a beam splitting and combining system according to another embodiment of the present invention. Referring to FIG. 3, a beam splitting and combining system 200a of the present embodiment is similar to the above beam splitting and combining system 200 (referring to FIG. 2) except for the following differences. In the beam splitting and combining system 200a, the dichroic unit 222′ is plate-shaped, and no prism may need to be disposed on the two sides of the dichroic unit 222′ for fixing. For example, the dichroic unit 222′ is, for example, a dichroic mirror.

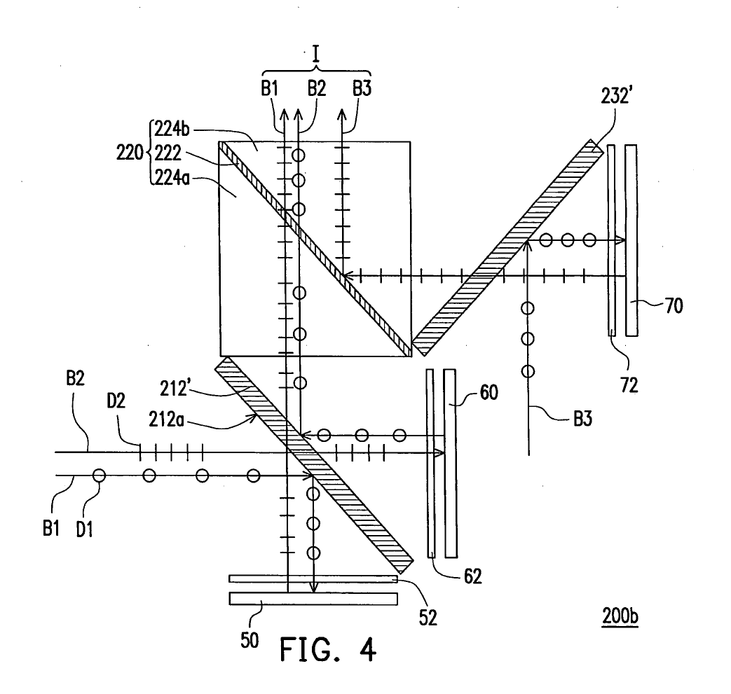

FIG. 4 is a structural diagram of a beam splitting and combining system according to yet another embodiment of the present invention. Referring to FIG. 4, a beam splitting and combining system 200b of the present embodiment is similar to the above beam splitting and combining system 200 (referring to FIG. 2) except for the following differences. In the beam splitting and combining system 200b, the first PBS unit 212′ and the second PBS unit 232′ are plate-shaped, and no prisms may need to be disposed on the two sides of the PBS units for fixing. For example, the first PBS unit 212′ and the second PBS unit 232′ are, for example, wire grid type polarizing beam splitters (wire grid type PBS).

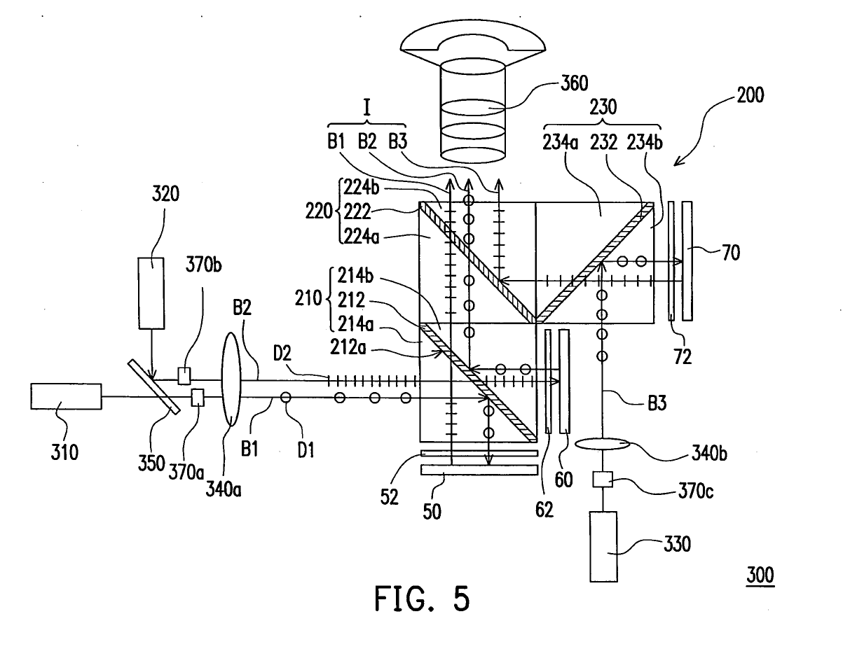

FIG. 5 is a structural diagram of an optical engine according to an embodiment of the present invention. Referring to FIG. 5, an optical engine 300 of the present embodiment includes the above first light valve 50, the above second light valve 60, the above third light valve 70, a first coherent light source 310, a second coherent light source 320, a third coherent light source 330 and the above beam splitting and combining system 200. The first coherent light source 310 is capable of providing the above first color beam B1 with the first polarization direction D1. The second coherent light source 320 is capable of providing the above second color beam B2 with the second polarization direction D2. The third coherent light source 330 is capable of providing the above third color beam B3.

In the present embodiment, the first, second and third coherent light source 310, 320 and 330 are, for example, laser light sources. In addition, before entering the beam splitting and combining system 200, the first, second and third color beams B1, B2, B3 emitted from the first, second and third coherent light sources 310, 320 and 330 pass through an optical module first to change the shapes of the first through third color beams B1˜B3 and to uniform the first through third color beams B1˜B3, or to make the first through third color beams B1˜B3 achieve other optical effects. More particularly, the first color beam B1 and the second color beam B2 may pass through an The diffraction optical elements), integration rods, other appropriate optical elements or any combinations of the above elements.

In addition, the first color beam B1 from the first coherent light source 310 and the second color beam B2 from the second coherent light source 320 may be combined first through a beam combining element 350, so that both two beams may enter the first PBS unit 212 through the light source side 212a. In the present embodiment, the beam combining element 350 is, for example, a dichroic mirror. However, in other embodiments, the beam combining element 350 may also be a dichroic prism, an X prism or other appropriate beam combining elements. Besides, a projection lens 360 is disposed on the optical path of image beam I emitted from the dichroic unit 222 in the present embodiment, so that the image beam I is projected to a screen (not shown) to form display images.

In the present embodiment, before entering the beam splitting and combining system 200, the first through third color beams B1˜B3 which are emitted from the first through third coherent light sources 310˜330 pass through the wave plates 370a, 370b and 370c, respectively. The polarization directions of the first through third color beams B1˜B3 may be adjusted by rotating the wave plates 370a, 370b and 370c, and the wave plates 370a, 370b and 370c are, for example, half-wave plates. However, in other embodiments, the polarization direction of the first through third color beams B1˜B3 may be adjusted by rotating the first through third coherent light sources 310˜330 directly without passing through the wave plates 370a, 370b and 370c.

Based on the above descriptions, in the optical engine 300 of the present embodiment, since the beams (such as the first, second and third color beams B1, B2 and B3) emitted by the coherent light sources (such as the first, second and third coherent light sources 310, 320 and 330) are polarized beams, the PCS is not needed in the optical engine 300 to polarize the beams. Therefore, the intensity of the beams being lost as the result of the beam passing through the PCS is avoided. In this way, the optical engine 300 of the present embodiment is able to provide display images with higher brightness.

In addition, since the beams emitted from the coherent light sources are well collimated and the divergence angles of the beams are small, the present embodiment does not need many lens to converge the beams. In this way, the lengths of the optical path which the beams travel in the optical engine 300 are reduced, such that the volume of the optical engine 300 is reduced. When the optical engine 300 is used in a rear projection television (RPTV), the thickness of the RPTV is thinner as a result. Moreover, since the optical engine 300 uses coherent light sources with a good collimation property, the design for the divergence angles of beams has more flexibility in the present embodiment.

In addition, the structure of the beam splitting and combining system 200 is simpler than that of the beam splitting and combining system of prior arts, and no PCS is needed in the optical engine 300 of the present embodiment, and not many lenses are needed to converge the beams to the beam splitting and combining system 200, such that the cost of the optical engine 300 of the present embodiment is lower.

It should be noted that the beam splitting and combining system used in the optical engine is not limited to the above beam splitting and combining system 200 in the present invention. In other embodiments, the optical engine may also use the beam splitting and combining system of other above embodiments, e.g. the beam splitting and combining systems 200a, 200b, etc.

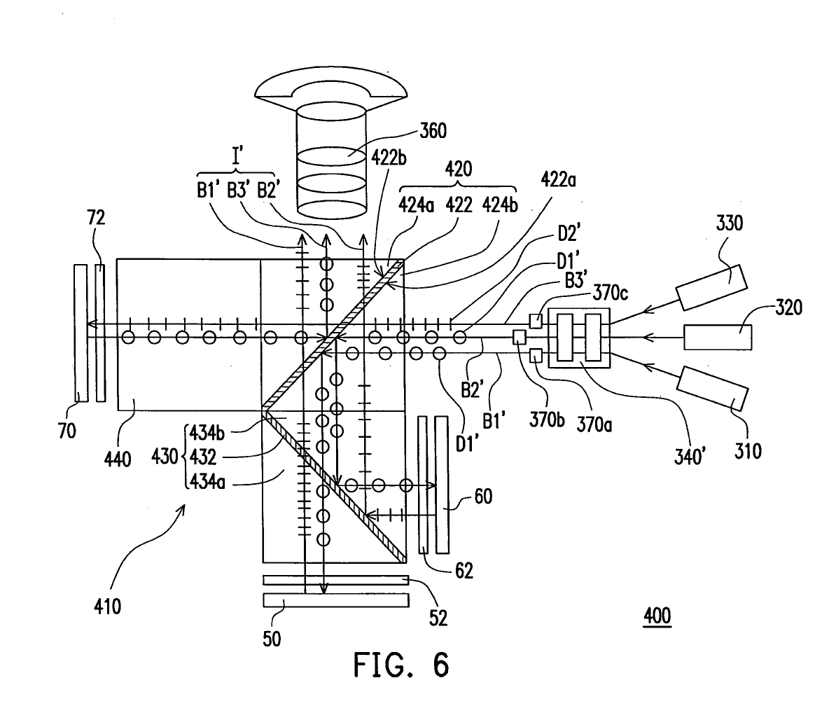

FIG. 6 is a structural diagram of an optical engine according to another embodiment of the present invention. An optical engine 400 of the present embodiment is partially similar to the above optical engine 300 (referring to FIG. 5) except for the following differences. In the optical engine 400 of the present embodiment, the first coherent light source 310 is capable of providing a first color beam B1′ with a first polarization direction D1′. The second coherent light source 320 is capable of providing a second color beam B2′ with the first polarization direction D1′. The third coherent light source 330 is capable of providing a third color beam B3′ with a second polarization direction. In addition, the above beam splitting and combining system 200 (referring to FIG. 5) is replaced by the beam splitting and combining system 410 in the present embodiment.

The beam splitting and combining system 410 includes a PBS unit 422 and a dichroic unit 432. The first color beam B1′ from the first coherent light source 310 and the second color beam B2′ from the second coherent light source 320 travel to the PBS unit 422, and are then emitted from a first surface 422a of the PBS unit 422. The third color beam B3′ from the third coherent light source 330 travels to the PBS unit 422, and is then emitted from a second surface 422b of the PBS unit 422. In the present embodiment, the first polarization direction D1′ is substantially perpendicular to the second polarization direction D2′. More particularly, the first polarization direction D1′ is, for example, S polarization direction, while the second polarization direction D2′ is, for example, P polarization direction. In the present embodiment, the first color beam B1′ and the second color beam B2′ with S polarization direction are incident on the first surface 422a of the PBS unit 422, then reflected by the PBS unit 422 and emitted from the first surface 422a of the PBS unit 422. In addition, the third color beam B3′ with P polarization direction enters the PBS unit 422 through the first surface 422a, then passes through the PBS unit 422 and is emitted from the second surface 422b of the PBS unit 422. However, in other embodiments, the first polarization direction D1′ and the second polarization direction D2′ may be P polarization direction and S polarization direction respectively, and the first color beam B1′ and the second color beam B2′ may pass through the PBS unit 422, while the third color beam B3′ may be reflected by the PBS unit 422. In the present embodiment, the third color beam B3′ emitted from the second surface 422b is reflected back to the second surface 422b by the third light valve 70.

The dichroic unit 432 is disposed on the optical path of the first color beam B1′ and the second color beam B2′ from the first surface 422a. The first color beam B1′ from the first surface 422a passes through the dichroic unit 432, is reflected by the first light valve 50, passes through the dichroic unit 432 and returns to the first surface 422a sequentially. The second color beam B2′ from the first surface 422a is reflected by the dichroic unit 432, is reflected by the second light valve 60, is reflected by the dichroic unit 432 and returns to the first surface 422a. The first, second and third color beams B1′, B2′ and B3′ returned from the first, second and third light valves 50, 60 and 70 to the PBS unit 422 are combined into an image beam I′ by the PBS unit 422.

More particularly, after being reflected by the first light valve 50, the first color beam B1′ with S polarization direction carries the image provided by the first color valve 50 and becomes the first color beam B1′ with P polarization direction. Next, the first color beam B1′ with P polarization direction returns to the first surface 422a, passes through the PBS unit 422 and is emitted from the second surface 422b. On the other hand, after being reflected by the second light valve 60, the second color beam B2′ with S polarization direction carries the image provided by the second color valve 60 and becomes the second color beam B2′ with P polarization direction. Next, the second color beam B2′ with P polarization direction returns to the first surface 422a, passes through the PBS unit 422, and is emitted from the second surface 422b. In addition, after being reflected by the third light valve 70, the third color beam B3′ with P polarization direction carries the image provided by the third color valve 70 and becomes the third color beam B3′ with S polarization direction. Then, the third color beam B3′ is incident on the second surface 422b, reflected by the PBS unit 422 and emitted from the second surface 422b. The first, second and third color beams B1′, B2′ and B3′ emitted at the same time from the second surface 422b are combined into the image beam I′.

In the present embodiment, the beam splitting and combining system 410 further includes two prisms 424a and 424b which respectively lean against two opposite sides of the first PBS unit 422. One of the prisms (i.e. the prism 424a) is located on the optical path between the PBS unit 422 and the third light valve 70, and the other prism (i.e. prism 424b) is located on the optical path between the first PBS unit 422 and the dichroic unit 432. The PBS unit 422 is, for example, a PBS film, and the PBS unit 422, the prism 424a and the prism 424b may form a PBS prism 420.

On the other hand, the beam splitting and combining system 410 further includes two prisms 434a and 434b which respectively lean against two opposite sides of the dichroic unit 432. One of the prisms (i.e. the prism 434a) is located on the optical path between the dichroic unit 432 and the first light valve 50, and the other prism (i.e. the prism 434b) is located on the optical path between the dichroic unit 432 and the second light valve 60. The dichroic unit 432 is, for example, a dichroic film, and the dichroic unit 423, the prism 434a and the prism 434b may form a dichroic prism 430.

In order to make the length of the optical path from the third light valve 70 to the projection lens 360 close to that of the optical path from the first or second light valves 50 or 60 to the projection lens 360, an prism 440 may optionally be disposed on the optical path between the third light valve 70 and the PBS unit 422. The shape of the prism 440 may be similar to the shape of the PBS prism 420 or the shape of the dichroic prism 430. However, in the optical engine of other embodiments, the prism 440 may also not be used, but a certain distance is kept between the third light valve 70 and the PBS unit 422 instead to achieve that the lengths of the optical path from different light valves to the projection lens 260 are approximate.

In addition, the optical engine 400 of the present embodiment further includes an optical module 340′ disposed on the optical path between the first through third coherent light sources 310˜330 and the beam splitting and combining system 410 for altering the shapes of the first through third color beams B1′˜B3′ and uniforming the first through third color beams B1′˜B3′, or enabling the first through third color beams B1′˜B3′ to achieve other optical effects. The composition elements of the optical module 340′ may be as those of the above optical module 340a or 340b (referring to FIG. 5).

The optical engine 400 of the present embodiment also has the effects of the above optical engine 300 (referring to FIG. 5), which will not be repeated herein. In addition, it should be noted that at least one of the PBS unit and the dichroic unit may be plate-shaped in other embodiments, and no prism is needed to fix the shape and the location thereof. When the PBS unit is plate-shaped, the PBS unit may be wire grid type PBS. When the dichroic unit is plate-shaped, the dichroic unit may be dichroic mirror. An embodiment will be given as example to describe in detail below.

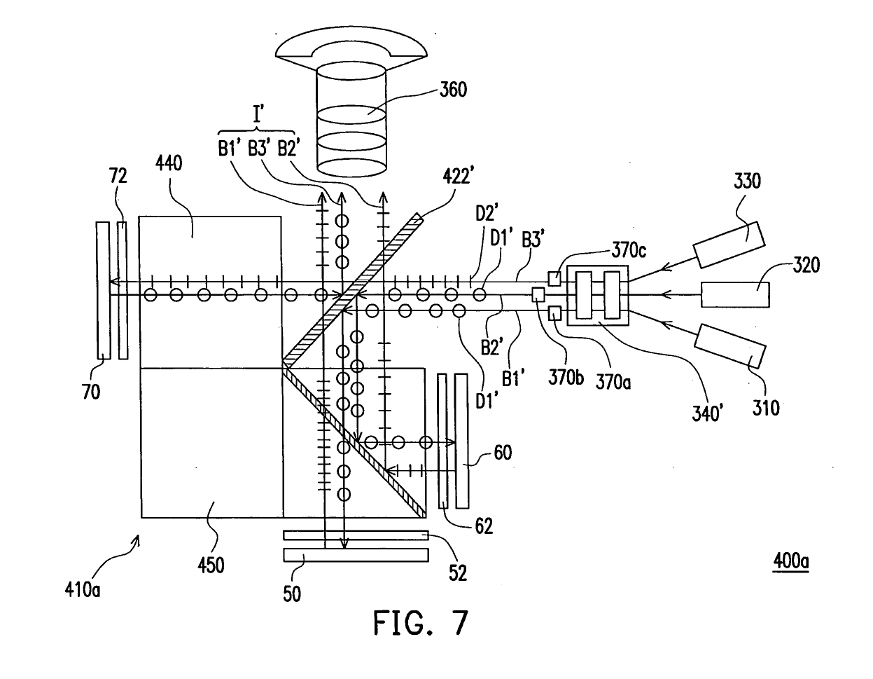

FIG. 7 is a structural diagram of an optical engine according to yet another embodiment of the present invention. Referring to FIG. 7, an optical engine 400a of the present embodiment is similar to the above optical engine 400 (referring to FIG. 6) except for the following differences. In a beam splitting and combining system 410a of the optical engine 400a, a PBS unit 422′ is plate-shaped, and no prism is needed to be disposed on two sides of the PBS unit 422′ for fixing. In addition, the beam splitting and combining system 410a may further include a prism 450 connecting the prism 440 and the dichroic prism 430 to increase the alignment accuracy of the beam splitting and combining system 410a.

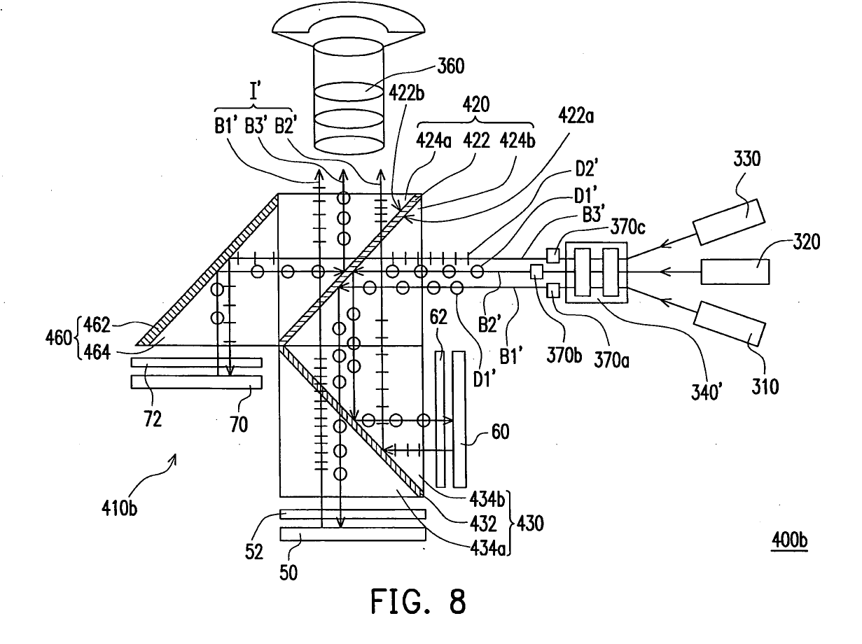

FIG. 8 is a structural diagram of an optical engine according to still another embodiment of the present invention. Referring to FIG. 8, an optical engine 400b of the present embodiment is similar to the above optical engine 400 (referring to FIG. 6) except for the following differences. The beam splitting and combining system 410b of the optical engine 400b does not have the above prism 440 (referring to FIG. 6), but the beam splitting and combining system 410b includes a reflection unit 462 instead. The reflection unit 462 is disposed on the optical path of the third color beam B3′ and between the PBS unit 422 and the third light valve 70, so as to reflect the third color beam B3′ to the third light valve 70. In addition, the beam splitting and combining system 410b may further include a prism 464 leaning against one side of the reflection unit 462 and located on the optical path of the third color beam B3′. The reflection unit 462 is, for example, a reflection film, and the reflection unit 462 and the prism 464 form a reflection prism 460. However, in other embodiments, the reflection unit may also be plate-shaped, and may not need to be fixed by the prism disposed on one side thereof. That is, the reflection unit may also be a reflection mirror.

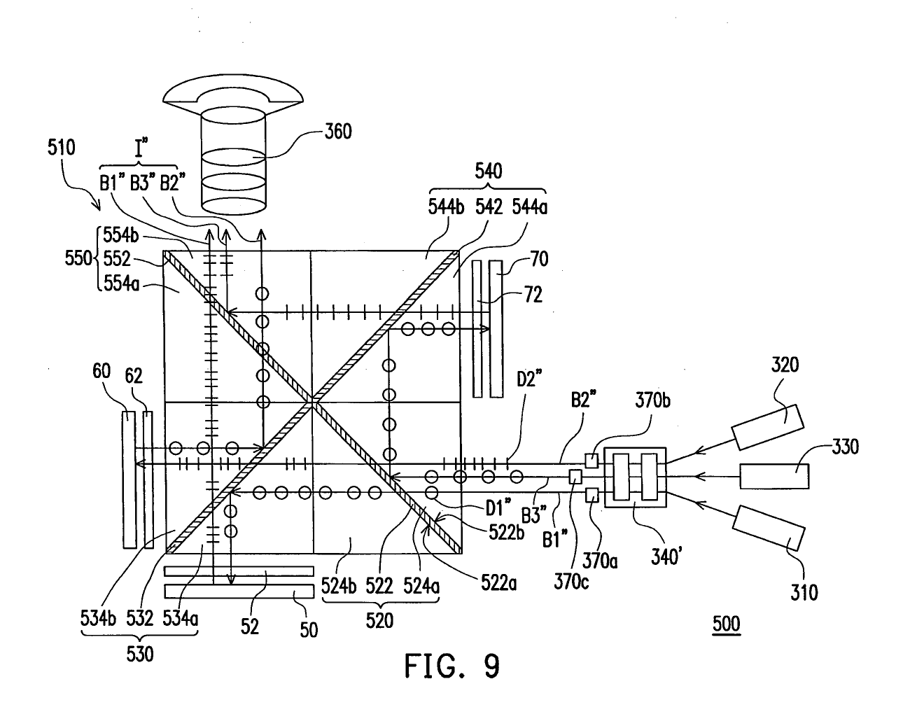

FIG. 9 is a structural diagram of an optical engine according to yet still another embodiment of the present invention. Referring to FIG. 9, an optical engine 500 of the present embodiment is partially similar to the above optical engine 400 (referring to FIG. 6) except for the following differences. In the optical engine 500 of the present embodiment, the first coherent light source 310 is capable of providing a first color beam B1″ with a first polarization direction D1″. The second coherent light source 320 is capable of providing a second color beam B2″ with a second polarization direction D2″. The third coherent light source 330 is capable of providing a third color beam B3″. In addition, the above beam splitting and combining system 410 (referring to FIG. 6) is replaced by the beam splitting and combining system 510 in the present embodiment.

The beam splitting and combining system 510 includes a first dichroic unit 522, a first PBS unit 532, a second PBS unit 542 and a second dichroic unit 552. The first color beam B1″ from the first coherent light source 310 and the second color beam B2″ from the second coherent light source 320 travel to the first dichroic unit 522, and are then emitted from a first surface 522a of the first dichroic unit 522. The third color beam B3″ from the third coherent light source 330 travel to the first dichroic unit 522, and is then emitted from a second surface 522b of the first dichroic unit 522. More particularly, in the present embodiment, all of the first through third color beams B1″˜B3″ are incident on the second surface 522b of the first dichroic unit 522. The first dichroic unit 522 is capable of allowing the first and second color beams B1″ and B2″ to pass through and to be emitted from the first surface 522a, and the first dichroic unit 522 is capable of reflecting the third color beam B3″ and emitting the third color beam B3″ from the second surface 522b. However, in other embodiment, the first dichroic unit may reflect the first and second color beams B1″ and B2″, and allow the third color beam B3″ to pass through. The first color beam B1″ from the first dichroic unit 522 is reflected by the first PBS unit 532, is reflected by the first light valve 50, and passes through the first PBS unit 532 sequentially. The second color beam B2″ from the first dichroic unit 522 passes through the first PBS unit 532, is reflected by the second light valve 60, and is reflected by the first PBS unit 532 to combine with the first color beam B1″ sequentially. The second dichroic unit 552 is disposed on the optical path of the first color beam B1″ and the second color beam B2″ combined together from the first PBS unit 532.

In the present embodiment, the first polarization direction D1″ is substantially perpendicular to the second polarization direction D2″. More particularly, the first polarization direction D1″ is, for example, S polarization direction, while the second polarization direction D2″ is, for example, P polarization direction. The first color beam B1″ with S polarization direction is reflected to the first light valve 50 by the first PBS unit 532. Then, the first color beam B1″ carries the image provided by the first light valve 50 and is reflected by the first light valve 50 to become the first color beam B1″ with P polarization direction. Afterward, the first color beam B1″ with P polarization direction passes through the first PBS unit 532 and travels to the second dichroic unit 552. On the other hand, the second color beam B2″ with P polarization direction passes through the first PBS unit 532 and travels to the second light valve 60. Then, the second color beam B2″ carries the image provided by the second light valve 60, and is reflected by the second light valve 60 to become the second color beam B2″ with S polarization direction. Afterward, the second color beam B2″ with S polarization direction is reflected by the first PBS unit 532 to the second dichroic unit 552. However, in other embodiments, the first polarization direction and the second polarization direction may also be P polarization direction and S polarization direction, respectively.

The second PBS unit 542 is capable of allowing the third color beam B3″ from the first dichroic unit 522 to travel to the third light valve 70, and is capable of allowing the third color beam B3″ reflected by the third light valve 70 to travel to the second dichroic unit 552. In the present embodiment, the polarization direction of the third color beam B3″ is substantially the same as the first polarization direction D1″. More particularly, the polarization direction of the third beam B3″ is, for example, S polarization direction. The third color beam B3″ from the first dichroic unit 522 and with S polarization direction is reflected to the third light valve 70 by the second PBS unit 522. Then, the first color beam B3″ carries the image of the third light valve 70, and is reflected by the third light valve 70 to become the third color beam B3″ with P polarization direction. Afterward, the third color beam B3″ with P polarization direction passes through the second PBS unit 542 and travels to the second dichroic unit 552.

In other embodiments, the polarization direction of the third color beam may also be substantially the same as the second polarization direction or be other appropriate directions. For example, the polarization direction of the third color beam is P polarization direction, and the third color beam passes through the second PBS unit 542, is reflected by the third light valve 70 and is reflected to the second dichroic unit 552 by the second PBS unit 542 sequentially.

In the present embodiment, the second dichroic unit 552 is capable of combining the first, second and third color beams B1″, B2″ and B3″ into an image beam I″. More particularly, in the present embodiment, the second dichroic unit 552 allows the first color beam B1″ and the second color beam B2″ to pass through, and reflects the third color beam B3″, so that the first through third color beams B1″˜B3″ are combined into the image beam I″. However, in other embodiments, the second dichroic unit allows the third color beam B3″ to pass through, and reflects the first color beam B1″ and the second color beam B2″. In this way, the effect of combining the first through third color beams B1″˜B3″ into the image beam I″ is also achieved.

In the present embodiment, the beam splitting and combining system 510 further includes two prisms 524a and 524b which respectively lean against the two opposite sides of the first dichroic unit 522. One of the prisms (i.e. the prism 524a) is located on the optical path between the second PBS unit 542 and the first dichroic unit 522, and the other prism (i.e. the prism 524b) is located on the optical path between the first PBS unit 532 and the first dichroic unit 522. The dichroic unit 522 is, for example, a dichroic film, and the first dichroic unit 522, the prism 524a and the prism 524b form a dichroic prism 520.

In addition, the beam splitting and combining system 510 further includes two prisms 534a and 534b which respectively lean against two opposite sides of the first PBS unit 532. One of the prisms (i.e. the prism 534a) is located on the optical path between the first dichroic unit 522 and the first PBS unit 532, and the other prism (i.e. the prism 534b) is located on the optical path between the second dichroic unit 552 and the first PBS unit 532. The first PBS unit 532 is, for example, a PBS film, and the first PBS unit 532, the prism 534a and the prism 534b form a PBS prism 530.

Moreover, the beam splitting and combining system 510 further includes two prisms 554a and 554b which respectively lean against two opposite sides of the second dichroic unit 552. One of the prisms (i.e. the prism 554a) is located on the optical path between the first PBS unit 532 and the second dichroic unit 552, and the other prism (i.e. the prism 554b) is located on the optical path between the second PBS unit 542 and the second dichroic unit 552. The second dichroic unit 552 is, for example, a dichroic film, and the second dichroic unit 552, the prism 554a and the prism 554b form a dichroic prism 550.

Besides, the beam splitting and combining system 510 further includes two prisms 544a and 544b which respectively lean against two opposite sides of the second PBS unit 542. One of the prisms (i.e. the prism 544a) is located on the optical path between the first dichroic unit 522 and the second PBS unit 542, and the other prism (i.e. the prism 544b) is located on the optical path between the second dichroic unit 552 and the second PBS unit 542. The second PBS unit 542 is, for example, a PBS film, and the second PBS unit 542, the prism 544a and the prism 544b form a PBS prism 540.

The optical engine 500 of the present embodiment also has the effects of the above optical engine 300 (referring to FIG. 5), which will not be repeated herein. In addition, it should be noted that at least one of the first dichroic unit, the second dichroic unit, the first PBS unit and the second PBS unit may be plate-shaped in other embodiments, and no prism is needed to fix the shape and the location thereof. When the first, second PBS units are plate-shaped, the first and second PBS unit may be wire grid type PBS. When the first and second dichroic units are plate-shaped, the first and second dichroic units may be dichroic mirrors.

Please refer to FIG. 6, according to another embodiment of the present invention, the first color beam B1′ is a green light beam, the second color beam B2′ is a red light beam, the third color beam B3′ is a blue light beam, and the first polarization direction D1′ is S polarization direction, and the second polarization direction D2′ is P polarization direction. All the light valves 50, 60, 70 described above may be reflective light valves, for example, these light valves 50, 60, 70 are Liquid Crystal On Silicon (LCOS) that is normally ON. Each LCOS utilized in this embodiment includes a plurality of pixels, and each pixel has an on state and an off state, the pixels which are in their on state change the polarization direction of an incident light beam incident thereon, while those in their off state don't change the polarization direction of the incident light beam incident thereon. The first, second and third color beams B1′, B2′, B3′ which are combined into an image beam I′ by the beam splitting and combining system 410 after being reflected by the light valves 50, 60, 70 above refers to the beams reflected by the pixels in their on-state in this embodiment.

However, as a matter of fact, the first, second and third color beams B1′, B2′, B3′ which are reflected by the pixels in off state and don't change their polarization direction also travel to the PBS unit, wherein the blue light beam (P polarization direction) with unchanged polarization direction passes through the PBS unit, but the red and green light beams (S polarization direction) with unchanged polarization direction are reflected by the PBS unit. So a large amount of beams with unchanged polarization direction don't enter into the projection lens 360.

In this embodiment, the light beams with S polarization direction (referred to as S-polarization light beam thereinafter) can be changed into the light beams with P polarization direction (referred to as P-polarization light beam thereinafter) by the pixels in on state in the light valves which may cooperate with a wave plate. And more specifically, the first light valve which cooperates with a ¼ wave plate changes an S-polarization green light beam into a P-polarization one.

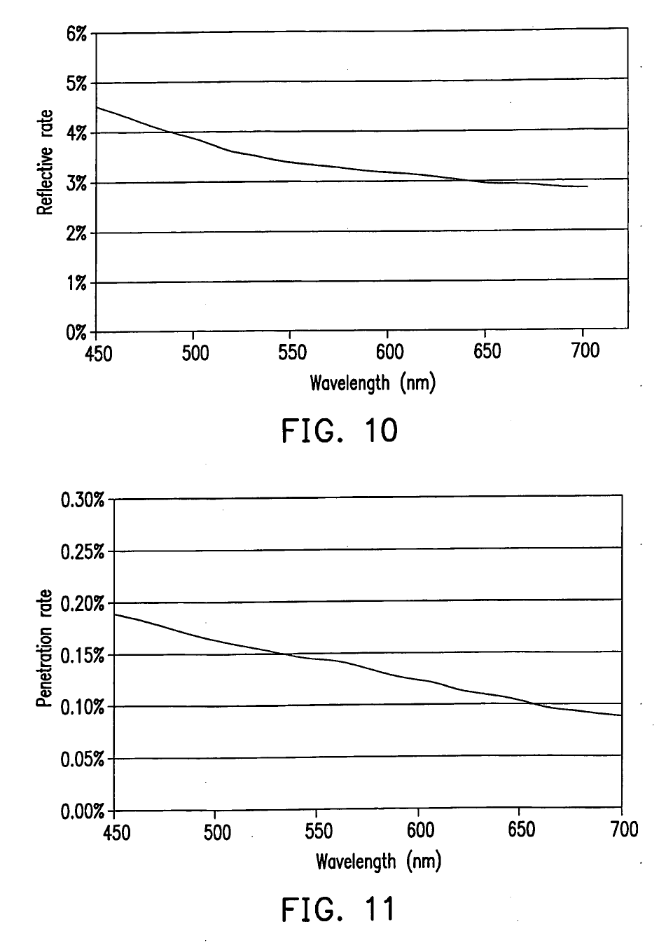

FIG. 10 is a curve of reflective rate of P-polarization light beams as a function of wavelength, while FIG. 11 is a curve of penetration rate of S-polarization light beams as a function of wavelength. It can be seen from FIG. 10, though a large amount of P-polarization light beams pass through the PBS unit, but a small part (approximately 2.8%˜4.5%) of the P-polarization light beams are still reflected by the PBS unit. It can be seen from FIG. 11, though a large amount of S-polarization light beams are reflected by the PBS unit, but a small part (approximately 0.08%˜0.2%) of the S-polarization beams still pass through the PBS unit. Therefore, a small part of the blue beams, red beams, and green beams that are reflected by the pixels in off state and don't change their polarization direction, still enter into the projection lens 360.

However, because human's eyes are relatively sensitive to the green light, according to this embodiment of the present invention, the green beams which travel to the PBS 422 and don't change their polarization direction is particularly designed to be beams with S polarization direction other than P polarization direction, and under such a condition, only about 0.08%˜0.2% of the green light beams that are reflected by the pixels in off state and don't change their polarization direction pass through the PBS 422 and enter the projection lens 360. So, the negative effects on the image contrast due to the fact that green light beams that are reflected by the pixels in off state and don't change their polarization direction enter the projection lens 360 are significantly reduced, and therefore the image contrast is improved.

To sum up, compared with the prior arts, the structure of the beam splitting and combining system according to an embodiment of the present invention is simpler, such that the volume of the beam splitting and combining system is smaller, and the cost of that is less. In addition, the beam splitting and combining system may be applied in the optical engine with coherent light sources. In the optical engine according to an embodiment of the present invention, since the beams emitted from the coherent light sources is polarized beams, a PCS is not needed to polarize the beams, which makes the intensity of the beams not be lost due to the beams passing through the PCS. In this way, the optical engine provides display images with higher brightness.

Moreover, since the coherent light source has a good collimation property, the divergence angle of the beam emitted by the coherent light source is very small, so as to make not many lenses be needed to converge the beam. In this way, the lengths of the optical paths which the beams travel in the optical engine are shortened, and the volume of the optical engine is reduced as a result. Besides, since the optical engine uses coherent light sources with a good collimation property, the design of the divergence angles of the beams has more flexibility.

Furthermore, the structure of the beam splitting and combining system according to an embodiment of the present invention is simpler than the beam splitting and combining system of the prior arts, and no PCS is needed in the optical engine of the embodiment, and not many lenses are needed to converge the beams to the beam splitting and combining system, such that the cost of the optical engine of the embodiment is lower.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed:

1. An optical engine, comprising:
a first light valve;
a second light valve;
a third light valve;
a first coherent light source, capable of providing a first color beam with a first polarization direction;
a second coherent light source, capable of providing a second color beam with a second polarization direction;
a third coherent light source, capable of providing a third color beam; and
a beam splitting and combining system, comprising:
a first polarizing beam splitting unit (PBS unit), wherein the first color beam incident from a light source side of the first PBS unit and having the first polarization direction is reflected by the first PBS unit, is reflected by the first light valve, and passes through the first PBS unit sequentially, and wherein the second color beam incident from the light source side of the first PBS unit and having the second polarization direction passes through the first PBS unit, is reflected by the second light valve, and is reflected by the first PBS unit to combine with the first color beam sequentially;
a dichroic unit, disposed on an optical path of the first color beam and the second color beam combined together from the first PBS unit; and
a second PBS unit, capable of allowing the third color beam to travel to the third light valve, and capable of allowing the third color beam reflected by the third light valve to travel to the dichroic unit, wherein the dichroic unit is capable of combining the first, second and third color beams into an image beam.

2. The optical engine according to claim 1, wherein the beam splitting and combining system further comprises two prisms respectively leaning against two opposite sides of the first PBS unit, one of the prisms is located on an optical path between the first PBS unit and the first light valve, the other one of the prisms is located on an optical path between the first PBS unit and the second light valve, and the first PBS unit is a polarizing beam splitting film (PBS film).

3. The optical engine according to claim 1, wherein the beam splitting and combining system further comprises two prisms respectively leaning against two opposite sides of the dichroic unit, one of the prisms is located on an optical path between the first PBS unit and the dichroic unit, the other one of the prisms is located on an optical path between the dichroic unit and the second PBS unit, and the dichroic unit is a dichroic film.

4. The optical engine according to claim 1, wherein the beam splitting and combining system further comprises two prisms respectively leaning against two opposite sides of the second PBS unit, one of the prisms is located on an optical path between the dichroic unit and the second PBS unit, and the second PBS unit is a PBS film.

5. The optical engine according to claim 1, wherein at least one of the first PBS unit, the second PBS unit and the dichroic unit is plate-shaped.

6. The optical engine according to claim 1, wherein the first polarization direction is substantially perpendicular to the second polarization direction and a polarization direction of the third color beam is substantially the same as the first polarization direction or the second polarization direction.

7. An optical engine, comprising:
a first light valve;
a second light valve;
a third light valve;
a first coherent light source, capable of providing a first color beam with a first polarization direction;
a second coherent light source, capable of providing a second color beam with the first polarization direction;
a third coherent light source, capable of providing a third color beam with a second polarization direction; and
a beam splitting and combining system, comprising:
a PBS unit, wherein the first color beam from the first coherent light source and the second color beam from the second coherent light source travel to the PBS unit and are then emitted from a first surface of the PBS unit, wherein the third color beam from the third coherent light source travel to the PBS unit and are then emitted from a second surface of the PBS unit, and wherein the third color beam emitted from the second surface is reflected back to the second surface by the third light valve; and
a dichroic unit, disposed on an optical path of the first color beam and the second color beam from the first surface, wherein the first color beam from the first surface passes through the dichroic unit, is reflected by the first light valve, passes through the dichroic unit and returns to the first surface sequentially, and wherein the second color beam from the first surface is reflected by the dichroic unit, is reflected by the second light valve, is reflected by the dichroic unit, and returns to the first surface sequentially,
wherein the first, second and third color beams returning to the PBS unit from the first, second and third light valves are combined into an image beam by the PBS unit.

8. The optical engine according to claim 7, wherein the beam splitting and combining system further comprises a reflection unit disposed on an optical path of the third color beam and between the PBS unit and the third light valve for reflecting the third color beam to the third light valve.

9. The optical engine according to claim 8, wherein the beam splitting and combining system further comprises a prism leaning against on one side of the reflection unit and located on the optical path of the third color beam, and the reflection unit is a reflection film.

10. The optical engine according to claim 8, wherein the first color beam is a green light beam, the second color beam is a red light beam, the third color beam is a blue light beam, and the first polarization direction is S polarization direction, the second polarization direction is P polarization direction, the PBS unit is adapted for reflecting the light beams with the S polarization direction and letting the light beams with the P polarization direction pass therethrough, and the first light valve changes the green light beam incident thereon with the S polarization direction into the green light beam incident thereon with the P polarization direction.

11. The optical engine according to claim 7, wherein the beam splitting and combining system further comprises two prisms respectively leaning against two opposite sides of the PBS unit, one of the prisms is located on an optical path between the PBS unit and the third light valve, the other one of the prisms is located on an optical path between the PBS unit and the dichroic unit, and the PBS unit is a PBS film.

12. The optical engine according to claim 7, wherein the beam splitting and combining system further comprises two prisms respectively leaning against two opposite sides of the dichroic unit, one of the prisms is located on an optical path between the dichroic unit and the first light valve, the other one of the prisms is located on an optical path between the dichroic unit and the second light valve, and the dichroic unit is a dichroic film.

13. The optical engine according to claim 7, wherein at least one of the PBS unit and the dichroic unit is plate-shaped.

14. An optical engine, comprising:
a first light valve;
a second light valve;
a third light valve;
a first coherent light source, capable of providing a first color beam with a first polarization direction;
a second coherent light source, capable of providing a second color beam with a second polarization direction;
a third coherent light source, capable of providing a third color beam; and
a beam splitting and combining system, comprising:
a first dichroic unit, wherein the first color beam from the first coherent light source and the second color beam from the second coherent light source travel to the first dichroic unit, and are then emitted from a first surface of the first dichroic unit, and wherein the third color beam from the third coherent light source travels to the first dichroic unit, and are then emitted from a second surface of the first dichroic unit;
a first PBS unit, wherein the first color beam from the first dichroic unit is reflected by the first PBS unit, is reflected by the first light valve, and passes through the first PBS unit sequentially, and wherein the second color beam from the first dichroic unit passes through the first PBS unit, is reflected by the second light valve, and is reflected by the first PBS unit to combine with the first color beam;
a second dichroic unit, disposed on an optical path of the first color beam and the second color beam combined together from the first PBS unit; and
a second PBS unit, capable of allowing the third color beam from the first dichroic unit to travel to the third light valve and capable of allowing the third color beam reflected by the third light valve to travel to the second dichroic unit, wherein the second dichroic unit is capable of combining the first, second and third color beams into an image beam.

15. The optical engine according to claim 14, wherein the beam splitting and combining system further comprises two prisms respectively leaning against two opposite sides of the first dichroic unit, one of the prisms is located on an optical path between the second PBS unit and the first dichroic unit, the other one of the prisms is on an optical path between the first PBS unit and the first dichroic unit, and the first dichroic unit is a dichroic film.

16. The optical engine according to claim 14, wherein the beam splitting and combining system further comprises two prisms respectively leaning against two opposite sides of the first PBS unit, one of the prisms is located on an optical path between the first dichroic unit and the first PBS unit, the other one of the prisms is located on an optical path between the second dichroic unit and the first PBS unit, and the first PBS unit is a PBS film.

17. The optical engine according to claim 14, wherein the beam splitting and combining system further comprises two prisms respectively leaning against two opposite sides of the second dichroic unit, one of the prisms is located on an optical path between the first PBS unit and the second dichroic unit, the other one of the prisms is located on an optical path between the second PBS unit and the second dichroic unit, and the second dichroic unit is a dichroic film.

18. The optical engine according to claim 14, wherein the beam splitting and combining system further comprises two prisms respectively leaning against two opposite sides of the second PBS unit, one of the prisms is located on an optical path between the first dichroic unit and the second PBS unit, the other one of the prisms is located on an optical path between the second dichroic unit and the second PBS unit, and the second PBS unit is a PBS film.

19. The optical engine according to claim 14, wherein at least one of the first dichroic unit, the second dichroic unit, the first PBS unit and the second PBS unit is plate-shaped.

20. The optical engine according to claim 14, wherein the first polarization direction is substantially perpendicular to the second polarization direction and a polarization direction of the third color beam is substantially the same as the first polarization direction or the second polarization direction.
